(19) United States
(12) Patent Application Publication
(10) Pub. No.: US 2006/0285158 A1
(43) Pub. Date: Dec. 21, 2006

(54) Image forming apparatus

(75) Inventors: Ikuo Nishida, Kanagawa-ken (JP); Mitsuhiro Kinoshita, Shizuoka-ken (JP)

Correspondence Address: SoCAL IP LAW GROUP LLP, 310 N. WESTLAKE BLVD. STE 120, WESTLAKE VILLAGE, CA, 91362, US

(73) Assignees: Kabushiki Kaisha Toshiba, Minato-ku (JP); Toshiba Tec Kabushiki Kaisha, Shinagawa-ku (JP)

(21) Appl. No.: 11/156,316

(22) Filed: Jun. 16, 2005

(51) Int. Cl. G06K 15/00

(52) U.S. Cl. 358/1.16

(57) ABSTRACT

An image forming apparatus according to the present invention allows a portable type external storage medium that can store image data to be attached to or detached from the apparatus main body. The image forming apparatus has a data protection means. In a normal operation, the data protection means allows image data stored in an internal storage device (HDD, etc.) or image data stored in the external storage medium to be processed in the image processor and outputs the processed image data to a printer section for printing. In the case where confidential image data is processed, the data protection means inhibits the image data from being saved in the internal storage device and allows only the image data from the external storage medium to be processed in the image processor after attachment of the external storage medium to the apparatus main body has been detected.

### BACKGROUND OF THE INVENTION

1. Field of the Invention

The present invention relates to an image forming apparatus such as an MFP (Multi-Function Peripherals) which is a digital complex machine, a copy machine, or a printer and, more particularly, to an image forming apparatus that prevents data leakage to thereby increase its security capability.

2. Description of the Related Art

In recent years, when performing electric sorting or making a large amount of copies, an image forming apparatus, for example, a digital complex machine (MFP) temporarily stores an image data in a storage device such as an HDD or FROM, reads out the image data from the storage device, applies processing to the read out data in a printer section and output it as a print. With the above configuration, electric sorting, duplex copying or the like is performed.

Further, a configuration in which a complex machine (MFP) and a PC (Personal Computer) are connected to each other through a network and image data created in the PC is printed out on the MFP side through the network is available.

U.S. Pat. No. 6,552,743 describes an electric image forming and printing system, which includes a camera interface that can link with a digital camera to transfer frames of digital image data from the digital camera to a digital camera-ready printer, allowing a user to edit and print out an electric image. Further, Jpn. Pat. Appln. Laid-Open Publication No. 2002-41247 describes an example of file copy operation in a computer system using a large-capacity storage medium, in which a memory device is inserted into a main body of a computer, the computer starts to copy the file on the memory device after recognizing it, the memory device is removed from the computer, and the removed memory device is then used to copy the file on a different hard disk or the like.

When a plurality of sheets of paper must be copied or printed in the above image forming apparatus, image data needs to be used repeatedly, so that the image data is temporarily stored in a storage device (HDD, etc.) incorporated in the apparatus. However, this is acknowledged as a problem in the light of security since a risk of data leakage and the like increase in the case where the image data remains in the storage device. For example, there is a possibility that highly confidential data is taken out of the storage device and stolen if the data is remain stored in the storage device. As a countermeasure, provided is an image forming apparatus, or an MFP equipped with a function that deletes the image data stored in the storage device or a function that encrypts the image data when it is written onto the storage device.

However, it takes time to delete the data in the storage device, so that when a user wants to continue using the MFP after one printing job has been completed, he or she cannot use it while the data stored in the storage device is being deleted. Depending on the data-deletion method, it is necessary to perform an overwrite of random data three times in order to completely delete magnetic data on an HDD. This takes time for the data to be completely deleted, with the result that unavailable time of the MFP is increased. Further, the number of accesses to the HDD increases, adversely affecting the life of the HDD.

Further, additional equipment is required in order to store the image data in the storage device in an encrypted manner, which increases cost or time taken for the encryption, with the result that the processing speed of image formation in the MFP may be adversely affected in some cases.

### BRIEF DESCRIPTION OF THE DRAWINGS

FIG. 1 is an explanatory view showing the entire configuration of an image forming system to which an image forming apparatus according to an embodiment of the present invention is applied;

FIG. 2 is a flowchart for explaining an operation of the image forming apparatus according to the embodiment of the present invention;

FIG. 3 is a flowchart for explaining an operation of the image forming apparatus according to a second embodiment of the present invention;

FIG. 4 is an explanatory view showing an example of an external storage medium used for the image forming apparatus according to a third embodiment;

FIG. 5 is a flowchart for explaining an operation of the image forming apparatus according to the third embodiment of the present invention; and

FIG. 6 is a flowchart for explaining an operation of the image forming apparatus according to a fourth embodiment of the present invention.

### DETAILED DESCRIPTION OF THE PREFERRED EMBODIMENTS

Throughout this description, the embodiments and examples shown should be considered as exemplars, rather than limitations on the apparatus of the present invention.

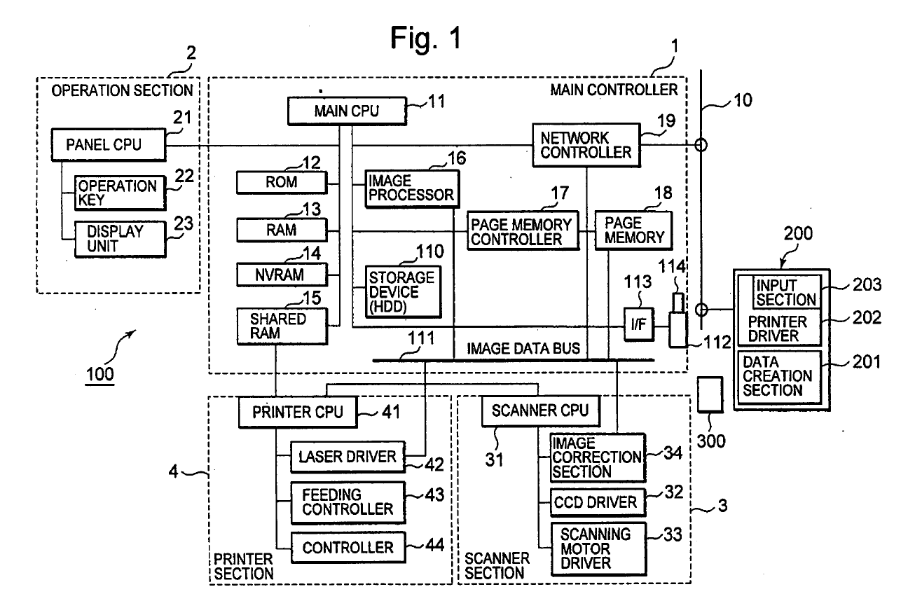

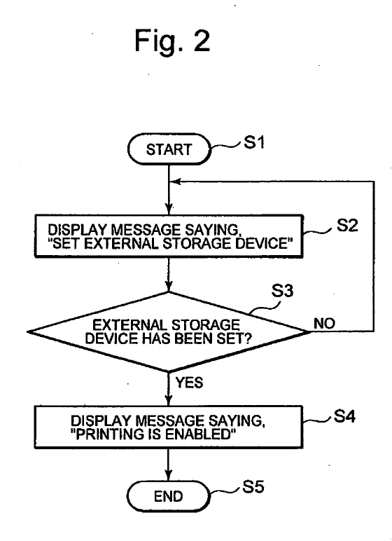

Embodiments of the present invention will be described below in detail with reference to the accompanying drawings. FIG. 1 is an explanatory view showing the entire configuration of an image forming system to which an image forming apparatus according to an embodiment of the present invention is applied, and FIG. 2 is a flowchart for explaining an operation of the image forming apparatus according to the embodiment of the present invention.

In FIG. 1, an image forming apparatus 100 is, for example, an MFP (Multi-Function Peripheral) which is a digital complex machine. The image forming apparatus 100 can be connected to an external device 200 such as a PC (Personal Computer), another complex machine, or the like through a network 10 such as LAN (Local Area Network). In the following description, an MFP and a client PC are exemplified as the image forming apparatus 100 and external device 200, respectively.

The external device 200 serves as a source of print data and includes a data creation section 201 that uses an application software to create print data such as text or graphic and a printer driver 202 that outputs, as PDL data (Page Description Language data), the image data sent from the data creation section to the image forming apparatus 100 through the network 10. An input section 203 is provided in the printer driver 202, through which a user issues an instruction such as a print command to the MFP 100.

The MFP 100 includes a main controller 1, an operation section 2, a scanner section 3, and a printer section 4.

The control system of the MFP 100 includes a plurality of CPUs, that is, a main CPU 11 in the main controller 1, a panel CPU 21 in the operation section 2, a scanner CPU 31 in the scanner section 3, and a printer CPU 41 in the printer section 4.

The main controller 1 includes a main CPU 11, a ROM (Read Only Memory) 12, a RAM 13, an NVRAM (Non-Volatile Memory) 14, a shared RAM 15, an image processor 16, a page memory controller 17, a page memory 18, a network controller 19, and an HDD 110 serving as a storage device. Reference numeral 111 is an image data bus.

The main CPU 11 controls the entire operation of the MFP 100. The ROM 12 stores a control program. The RAM 13 temporarily stores the control program and data. The NVRAM 14 is a battery (not shown) backed-up non-volatile memory whose storage contents are not erased even when a power source is turned off. The shared RAM 15 is used when a bidirectional communication is performed between the main CPU 11 and printer CPU 41.

The page memory controller 17 writes image data or reads out image data onto/from the page memory 18 in units of pages. The page memory 18 has a storage area large enough to store image data corresponding to a plurality of pages and can store data obtained by compressing image information from the scanner section 3 in units of pages.

The MFP 100 can exchange image data with the external device 200 through the network controller 19 connected to the network 10.

The HDD 110 temporarily stores image data acquired by the scanner section 3 or image data (text data or drawing image data) from the external device 200 in a compressed manner. The image data stored in the HDD 110 is subjected to various image processing in the image processor 16 and printed onto a paper by the printer section 4.

The operation section 2 includes a panel CPU 21 connected to the main CPU 11, various operation keys 22, and a display unit 23 comprising a liquid crystal panel. The user uses the operation keys 22 to input various settings such as the number of print pages, print size, or instruction of one-side printing or both sided printing. In addition, the user can select print modes (to be described later) by using the operation keys 22.

The scanner section 3 includes a scanner CPU 31 that controls the operation of the scanner, a ROM (not shown) that stores a scanner control program or the like, a RAM (not shown) for data storage, as well as a CCD driver 32 that drives a color image sensor, a scanning motor driver 33 that controls the rotation of a scanning motor, an image correction section 34 and so on. The scanner section 3 irradiates a document placed on a document table with an exposure lamp, receives a reflected light by the CCD to read out the document, and converts it into image data.

The image correction section 34 includes an A/D conversion circuit that converts analog signals of R, G, B output from the color image sensor into digital signals respectively, a shading correction circuit that corrects variation in the threshold level for an output signal resulting from fluctuation in the color image sensor readings, and a line memory that once stores the corrected digital signal sent from the shading correction circuit.

The printer section 4 includes a printer CPU 41 that controls the operation of the printer section, a ROM (not shown) that stores a control program or the like, and a RAM (not shown) for data storage, as well as a laser driver 42 that drives a laser, a feeding controller 43 that controls a paper feeding operation, and a controller 44 that performs charging, development, and image transfer.

The main CPU 11 performs bidirectional communication with the printer CPU 41 through the shared RAM (Random Access Memory) 15. The main CPU 11 issues an operation instruction, and the printer CPU 41 returns a status. Further, the printer CPU 41 and scanner CPU 31 are connected to each other through a serial communication link. The printer CPU 31 issues an operation instruction, and the scanner CPU 41 returns a status.

The image processor 16, page memory 18, network controller 19, image correction section 34, and laser driver 42 are connected to one another by the image data bus 111.

The MFP 100 further has a card slot section 112 to which an external storage medium 300 is attached. The card slot section 112 is connected to the main CPU 11 and image processor 16 through an interface (I/F) section 113. The external storage medium 300 is, for example, a portable storage device such as a PC card or memory card and is detachably attached to the MFP 100. The MFP 100 can write data and read out data onto/from the external storage medium 300 through the I/F section 113.

The MFP 100 further has a detector 114 that detects attachment and detachment of the external storage medium 300 to the card slot section 112. As the detector 114, a mechanical switch or photosensor that turns ON and OFF in response to the attachment/detachment of the external storage medium 300 can be used. The detection result of the detector 114 is sent to the main CPU 11.

The image forming apparatus according to the present invention is provided with the following data protection means in the light of security. That is, the abovementioned detector 114 is used as a function that determines whether the external storage medium 300 has been attached to the MFP 100, and in the case where a mode that demands secrecy is set by the user's key operation on the operation section 2 or where information indicating necessity of secrecy is transmitted from the external device 200 (hereinafter, referred to as “confidential mode”), image data saving in the HDD 110 is inhibited under the control of the main CPU 11. When attachment of the external storage medium 300 is detected, the image data is allowed to be stored and read out in/from the external storage medium 300, and the confidential image data is printed.

FIG. 2 is a flowchart for explaining the print operation according to a first embodiment.

Firstly, in the case where the confidential mode is set in step S1 at the time when a user operates the external device 200 to issue a print command of image data that the user wants to print to the MFP 100, a message saying, for example, “set external storage device” is displayed on the display unit 23 of the operation section 2 to prompt the user to insert the external storage medium 300 in step S2. When the external storage medium 300 is attached to the card slot 112 and the detector 114 detects the attachment in step S3, a massage saying, “printing is enabled” is displayed on the display unit 23. As a result, the image data is allowed to be stored and read out in/from the external storage medium 300, and printing is enabled in step S4.

In this case, a print command is issued from the external device 200 to the MFP 100 and, after that, the user moves to the MFP 100 and inserts the external storage medium 300 into the card slot 112 so as to start the print processing. In this manner, it is possible to perform printing without saving the confidential data in the HDD 110.

The above description has been made taking a case where the user operates the external device 200 to allow the MFP 100 to print the image. Basically the same operation is applied to the case where the user directly operates the MFP to copy document and insertion of the external storage medium 300 into the card slot 112 of the MFP 100 allows the MFP 100 to perform copying.

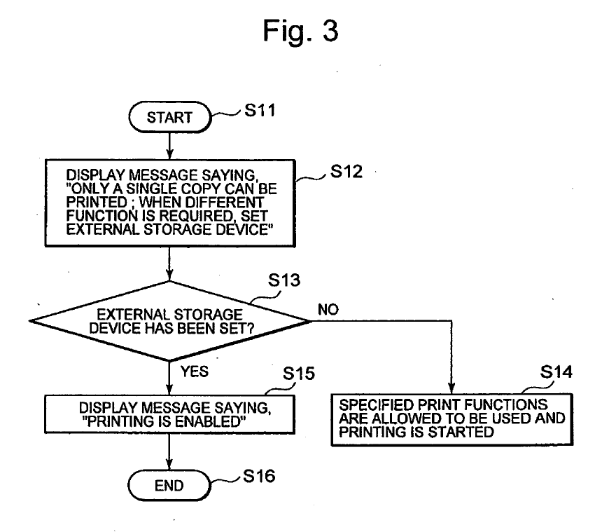

FIG. 3 is a flowchart for explaining the print operation according to a second embodiment.

Firstly, in the case where the confidential mode is set in step S11 at the time when a user operates the external device 200 to issue a print command of image data that the user wants to print to the MFP 100, a message saying, “only a single copy can be printed. When different function is required, set external storage medium.” is displayed on the display unit 23 of the operation section 2 in step S12.

Even in the case where the external storage medium 300 has not been attached in step S13, printing of a single copy is allowed and, in step S14, a single copy is printed out with only specified print functions allowed to be used. On the other hand, in the case where a plurality of sheets of paper are copied or printed, functions other than the specified functions are not allowed to be used unless the external storage medium 300 is attached to the card slot 112. When the external storage medium 300 is attached to the card slot 112 and the detector 114 detects the attachment in step S13, a message saying, “printing is enabled” is displayed in the display unit 23. As a result, in step S15, saving and readout of the image data in/from the external storage medium 300 are performed and printing is completed. In this manner, it is possible to perform printing without saving the confidential data in the HDD 110.

Also in the case of making a single copy as well as the above case, the image data read by the scanner section 3 is printed without being temporarily stored in the HDD 110. That is, only in the case of making a single copy, it is possible to perform copying without saving a confidential document in the HDD 110.

Further, the following configuration is conceivable as a third embodiment. That is, specified information, such as user information or permission information that allows the user to use only a predetermined print function is previously stored in the external storage device 300. The MFP 100 reads out the user information or permission information from the external storage device 300 attached to the image forming apparatus 100, identifies the stored contents and switches available functions depending on the contents.

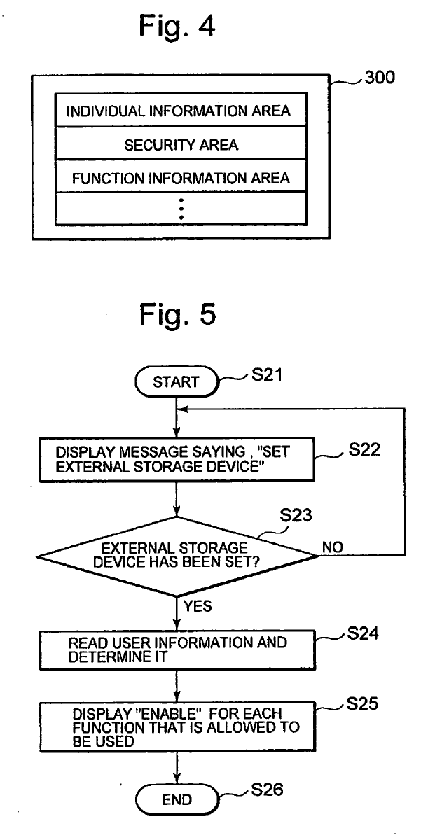

In this case, the memory area of the external storage device 300 includes, as shown in FIG. 4, an individual information area that stores user information, a security area that stores security level, and a function information area that stores information specifying the function allowed to be used in the MFP 100. For example, an identification number is registered as the user information and the same identification number is previously registered in the MFP 100. Only when the registered identification numbers correspond to each other, image data is allowed to be read out from the external storage device 300. As described above, the secrecy of the data is increased in the third embodiment.

It is only necessary for the security level to indicate confidential mode or normal node. As the permission information that identifies available functions, it is possible to set information that limits the number of print pages or print sets, or print mode such as color printing, as well as information that limits a common function such as both-sided printing, addition of date information, or addition of page number.

FIG. 5 shows a flowchart of the operation according to the third embodiment.

Firstly, in the case where the confidential mode is set in step S21 at the time when a user operates the external device 200 to issue a print command of image data that the user wants to print to the MFP 100, a message saying, “set external storage device” is displayed on the display unit 23 of the operation section 2 in step S22.

When the external storage medium 300 is attached to the card slot 112 and the detector 114 detects the attachment in step S23, the user information (identification number) that has been stored in the external storage medium 300 is read out and it is determined whether there exists a corresponding identification number in the MFP 100 in step S24. When there exists a corresponding number, the flow advances to step S25, where signs “enable” are displayed for each function allowed to be used on the display unit 23 of the operation section 2. As a result, printing is executed according to the print function allowed to be used in step S26 and completed.

As described above, saving and readout of the image data in/from the external storage medium 300 become possible and, the printing can be performed with print functions being limited for each user. In this embodiment, confidential data is not saved in the HDD 110.

The above description has been made taking a case where the image data from the external device 200 is printed. Also in the case of making a copy of document or the like, the image data read by the scanner section 3 is temporarily stored in the HDD 110 in general before printing. Therefore, in the case of making a copy of a confidential document, the confidential mode is set by the user's key operation on the operation section 2 and the user is prompted to insert the external storage medium 300 storing the user information (identification number) so that only the user whose identification number has been previously registered is allowed to make a copy. That is, in this configuration, copying cannot be performed until the external storage medium 300 has been inserted.

The above description has been made taking a case where confidential data is printed or copied. In the case where non-confidential data is printed or daily document or the like is copied, the normal mode is selected by the user's key operation on the operation section 2 or through the external device 200 and thereby printing and copying can be freely performed. In this case, data can be saved in the HDD 110.

In the above description, the MFP 100 includes the HDD 110 and confidential image data is inhibited from being saved in the HDD 110. Alternatively, however, a configuration in which the MFP 100 is not provided with the HDD 110 is conceivable as another embodiment. In this configuration, when the external storage medium 300 is attached to the card slot 112, the attachment state is detected, the image data is allowed to be saved and read out in/from the external storage medium 300, and printing is performed. In this case, the MFP 100 does not include the HDD 110, so that when the external storage medium 300 is attached to the card slot 112, the image data from the external device 200 is stored in the external storage medium in place of the HDD and thereby printing can be performed.

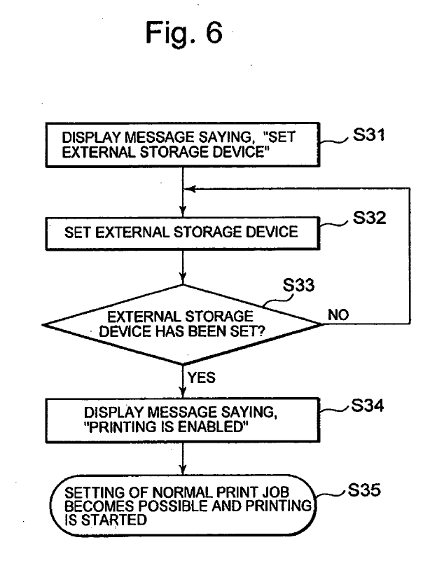

The flowchart of the operation in the above embodiment will be described with reference to FIG. 6. In step S31, a message saying, “set external storage device” is displayed in the display unit 23 of the operation section 2. In step S32, the user inserts the external storage medium 300 into the card slot 112. When the attachment of the external storage medium 300 is detected by the detector 114 in step S33, a message “printing is enabled” is displayed in step S34. In step S35, setting of a normal print job becomes possible and thereby printing can be performed.

In this example, printing cannot be started unless the user inserts the external storage medium, so that it is possible to further maintain the secrecy. Further, also in this example, when the user information and permission information that identifies functions that are allowed to be used in the MFP 100 are stored in the external storage medium 300, it is possible to set users that are allowed to perform copying, and to specify the function that is allowed to be used in the MFP 100. That is, it can be said that this example shows an image forming apparatus specialized in handling the confidential data.

As described above, according to the present invention, image data is not stored in the storage device provided in the MFP, such as the HDD 110, or the MFP does not include the HDD itself. Therefore, if the user simply manages his or her own storage device, it is possible to prevent the image data temporarily stored through the MFP 100 from being leaked to the third party. This eliminates the need for taking measures such as automatic deletion or encryption. Further, the storage of user's unique data in the storage device allows the apparatus side to identify the user, so that it is possible to provide a limit on the function that is allowed to be used for each user or it is possible to limit the number of copies.

Although exemplary embodiments of the present invention have been shown and described, it will be apparent to those having ordinary skill in the art that a number of changes, modifications, or alternations to the invention as described herein may be made, non of which depart from the spirit of the present invention. All such changes, modifications, and alternations should therefore be seen as within the scope of the present invention.

What is claimed is:

1. An image forming apparatus having an internal storage device which can store image data, comprising:
an interface which allows a portable type external storage medium that can store image data to be attached to or detached from the image forming apparatus main body;
an image processor which applies processing to image data stored in the internal storage device or image data stored in the external storage medium;
a printer section which prints image data output from the image processor; and
data protection means for inhibiting image data from being saved in the internal storage device when a predetermined print mode is set, for allowing only the image data from the external storage medium to be processed in the image processor, and for outputting the processed image to the printer section.

2. The image forming apparatus according to claim 1, further comprising detection means for detecting attachment of the external storage medium to the apparatus main body, wherein
the data protection means saves image data in the external storage medium when the attachment of the external storage medium is detected.

3. The image forming apparatus according to claim 1, wherein
the predetermined print mode is a confidential mode, and
in the confidential mode, the data protection means performs control such that image data from the external storage medium is processed in the image processor for printing but is inhibited from being saved in the internal storage device.

4. The image forming apparatus according to claim 1, wherein
the external storage medium can store image data created by an external device connected to the image forming apparatus through a network.

5. The image forming apparatus according to claim 1, comprising a scanner section that reads an image, wherein
when the external storage medium is not attached, the data protection means performs control such that after the image data read by the scanner section has been processed in the image processor, printing of only a single copy of the image data is allowed to be performed.

6. An image forming apparatus having an internal storage device that can store image data, comprising:
an interface that allows a portable type external storage medium that can store specified information including user information and image data to be attached to or detached from the image forming apparatus main body;
an image processor that applies processing to image data stored in the internal storage device or image data stored in the external storage medium;
a printer section that prints image data output from the image processor; and
data protection means for inhibiting image data from being saved in the internal storage device when the external storage medium is attached to the apparatus main body, for allowing the image data from the external storage medium to be processed in the image processor after identifying the user information, and for outputting the processed image to the printer section.

7. The image forming apparatus according to claim 6, further comprising detection means for detecting attachment of the external storage medium to the apparatus main body, wherein
the data protection means inhibits image data from being saved in the internal storage device when attachment of the external storage medium is detected.

8. The image forming apparatus according to claim 6, wherein
the data protection means previously registers identification information corresponding to the user information in the image forming apparatus, allows image data from the external storage medium to be processed in the image processor when the user information stored in the external storage medium and previously registered identification information correspond to each other, and outputs the processed image data to the printer section.

9. The image forming apparatus according to claim 6, wherein
the specified information stored in the external storage medium includes permission information for allowing a use of a specified function of print function available in the image forming apparatus as well as the user information, and
the data protection means allows only a use of the function specified by the permission information.

10. The image forming apparatus according to claim 9, wherein
the permission information is information that limits the number of print pages or print sets, and
the data protection means allows printing to be performed when the number of print pages or print sets falls within the limit.

11. An image forming apparatus comprising:
an interface that allows a portable type external storage medium that can store image data to be attached to or detached from the image forming apparatus main body;
an image processor that applies processing to image data stored in the external storage medium;
a printer section that prints image data output from the image processor;
detection means for detecting attachment of the external storage medium to the apparatus main body; and
data protection means for receiving a print job when attachment of the external storage medium is detected by the detection means, for allowing the image data from the external storage medium to be processed in the image processor and for outputting the processed image to the printer section.

12. The image forming apparatus according to claim 11, wherein
the detection means is a switch whose state is changed depending on attachment/detachment of the external storage medium.
